(19) United States
(12) Patent Application Publication
(10) Pub. No.: US 2012/0246565 A1
(43) Pub. Date: Sep. 27, 2012

(54) GRAPHICAL USER INTERFACE FOR DISPLAYING THUMBNAIL IMAGES WITH FILTERING AND EDITING FUNCTIONS

(75) Inventor: Danny Naoshi Kumamoto, Garden Grove, CA (US)

(73) Assignee: KONICA MINOLTA LABORATORY U.S.A., INC., San Mateo, CA (US)

(21) Appl. No.: 13/071,042

(22) Filed: Mar. 24, 2011

(51) Int. Cl. G06F 3/048; G06F 17/00

(52) U.S. Cl. 715/273

(57) ABSTRACT

An enhanced graphical user interface (GUI) for displaying a main document image and multiple thumbnail images, with filtering functions to allow the user to display selected pages as thumbnail images. In particular, the GUI is implemented in a Make Ready program used in a print shop to manipulate documents before printing. Each page of the document being processed by the Make Ready program is assigned one of multiple processing phases (or processing status values), depending on whether any editing changes are required, and whether any required changes have been made or all required changes are completed. The operator can selectively display pages of a certain phase as thumbnail images, and use this display to make editing changes to the pages. The program automatically updates the phase assignment for a page after changes are made to it. The operator can also manually update the phase of a page.

This application is related to commonly owned U.S. patent application Ser. No. 13/016702, filed Jan. 28, 2011, and commonly owned U.S. patent application Ser. No. 13/016787, filed Jan. 28, 2011, both of which are pending and are herein incorporated by reference in their entireties.

### BACKGROUND OF THE INVENTION

1. Field of the Invention

This invention relates to a graphical user interface, and in particular, it relates to a graphical user interface for displaying a main document image and multiple thumbnail images with filtering and editing functions.

2. Description of Related Art

In a print shop environment, a document to be printed along with a job ticket (a set of parameters defining various printing requirements) is referred to as a print job. Each print job goes through multiple stages of processing in the print shop, referred to as a workflow. Make Ready refers to a stage of the workflow during which the print job is modified, including, for example, making image and text manipulations within the document, setting paper and tab insertions, defining finishing settings, etc. When these actions are complete, the print job is ready for printing. Because of its complexity, Make Ready can be a labor-intensive process.

Typically, an operator opens the document in the Make Ready software program, and uses various graphical user interface tools provided by the Make Ready program to manipulate the print job. The Make Ready program typically displays one page of the document as a main image display and simultaneously displays multiple pages of the document as thumbnail images.

In many computer applications, including conventional Make Ready programs mentioned above, a document is displayed in a graphical user interface (GUI) in such a way that a plurality of pages of the document are displayed as thumbnail images and one or more selected pages of the document are displayed as the main document image. A thumbnail is a smaller size, lower resolution image of a page. The main document image is substantially larger and has a higher resolution than the thumbnail images. For example, when the document contains text, the main document image typically displays the text in legible sizes, while the text in thumbnail images is often illegible. In addition, the applications typically allow the user to operate on the main document image (e.g., edit the content of that page), while the thumbnail images are often displayed as non-editable images. The user can select a page of the document by clicking on a thumbnail image and have that page displayed as the main image for editing purposes.

### SUMMARY

The present invention provides an improved GUI for displaying a document including both a main document image and a plurality of thumbnail images, where a filtering function is implemented to selectively display pages of the document as the thumbnail images. The improved GUI display is useful in a Make Ready program for processing a document before printing.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a computer-implemented method for processing a document containing multiple pages, which includes: (a) assigning a processing status value to each page of the document, the assigned processing status value being one of a plurality of pre-defined processing status values which correspond to a plurality of processing statuses; (b) receiving a first input from an operator specifying one of the plurality of pre-defined processing status values; (c) displaying a plurality of pages of the document having the specified processing status value as thumbnail images in a graphical user interface (GUI) display; (d) displaying one page of the document as a main image in the GUI display; (e) carrying out editing changes on one or more of the pages displayed as thumbnail images or the main image; and (f) updating the processing status value of each page of the document for which editing changes have been carried out, wherein the updating is performed automatically or in response to a second input received from the operator.

The processing status value for each page may represent whether any editing is required for the page and whether any editing has been done for the page, and may include a first processing status value which indicates that changes are required for the page and no editing has been done on the page, a second processing status value which indicates that changes were required for the page and that some of the required changes have been made but not all are complete, a third processing status value which indicates that no changes are required for the page, and a fourth processing status value which indicates that changes were required for the page and that all required changes have been made and no additional work is required. They may further include a fifth processing status value which indicates that the page is deleted.

The document may be a part of a print job which includes the document and a job ticket containing one or more job ticket parameters describing printing requirements, wherein the assigning step (a) includes applying one or more filters to each page to determine whether any editing is required for that page, wherein each filter describes one or more editing changes to be made depending on contents of the page and/or the job ticket parameters relevant to the page.

In another aspect, the present invention provides a computer program product comprising a computer usable non-transitory medium (e.g. memory or storage device) having a computer readable program code embedded therein for controlling a data processing apparatus, the computer readable program code being configured to cause the data processing apparatus to execute the above methods.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a Make Ready process according to an embodiment of the present invention.

FIGS. 2a-2d schematically illustrate GUI windows for displaying a main image and multiple thumbnails, which may be used to implement the process of FIG. 1.

FIG. 3 illustrates a computer system in which embodiments of the present invention may be implemented.

### DETAILED DESCRIPTION OF PREFERRED EMBODIMENTS

Embodiments of the present invention provides an enhanced graphical user interface (GUI) for displaying a main document image and multiple thumbnail images, with filtering functions to allow the user to selectively display selected pages of the document as thumbnail images. One particular application of the GUI is a Make Ready program used in a print shop to manipulate documents before printing.

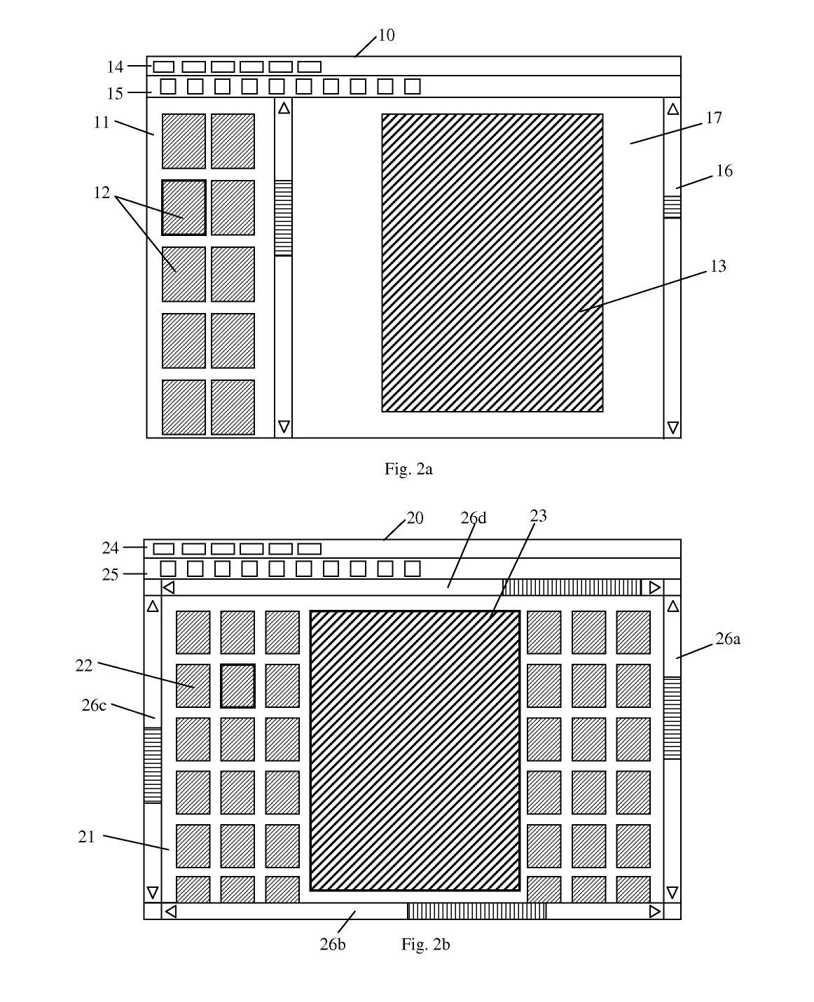

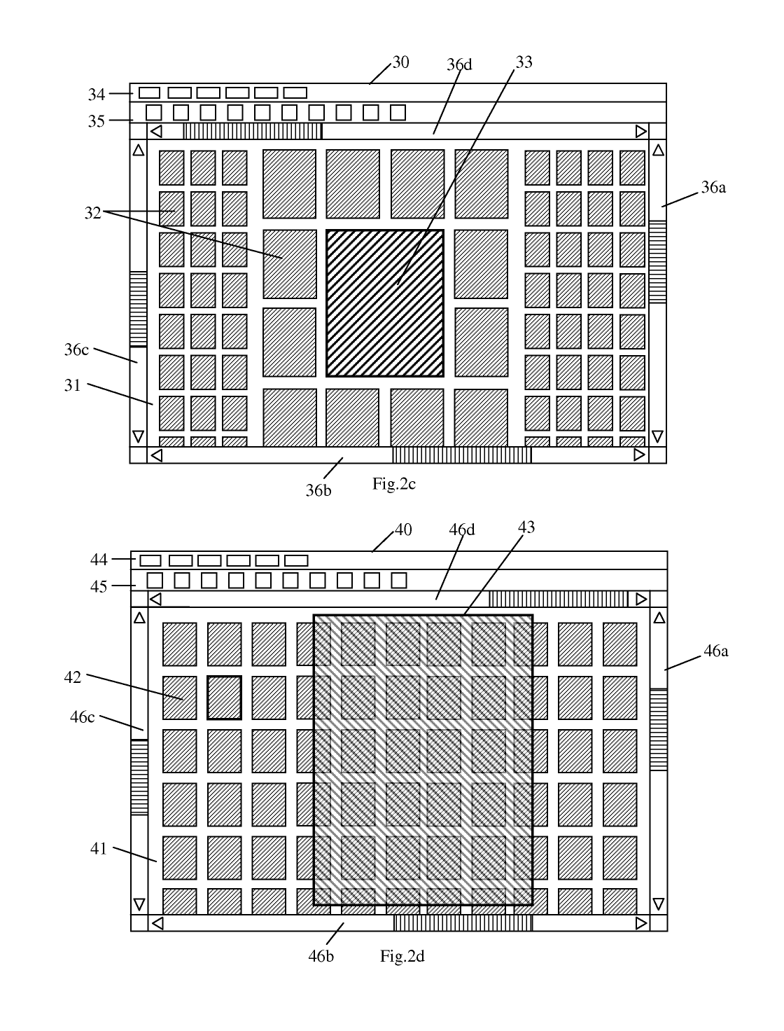

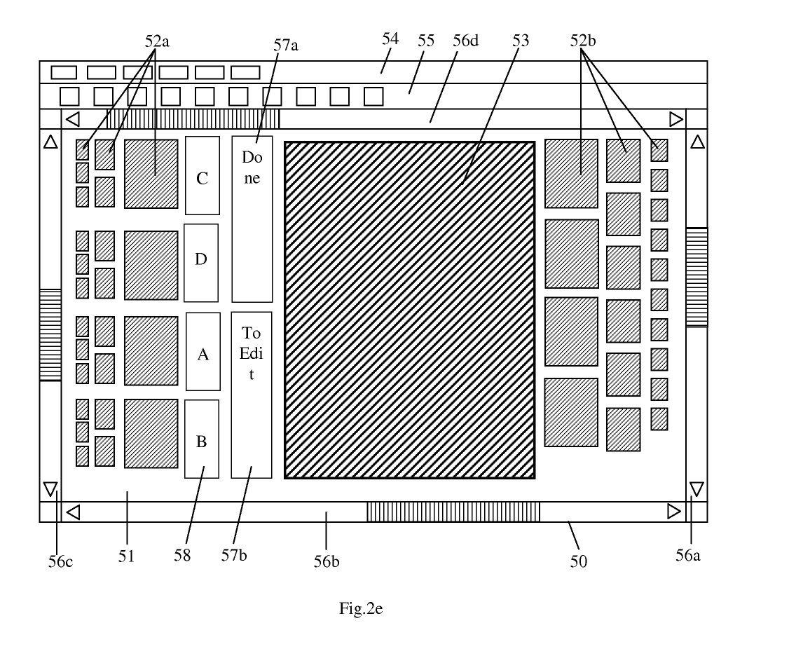

FIGS. 2a-2d schematically illustrates a number of GUI layouts that can be used to implement embodiments of the present invention. FIG. 2a illustrates a typical conventional GUI layout. In this layout, the thumbnail images 12 are located in a thumbnail pane 11 (a pane is a portion of the window 10, often with its own navigation tools) and the main document image 13 is located in a main image pane 17, where the two panes are separate window areas each having a defined, often adjustable, size. When all thumbnail images of the document cannot fit within the finite size of the thumbnail pane, scroll bars are provided for the thumbnail pane 11 to allow the user to scroll through the thumbnail images.

FIGS. 2b-2d illustrate some GUI layouts described in the above-referenced commonly owned U.S. patent application Ser. Nos. 13/016702 and 13/016787. The GUI window 20 (or 30, 40) has a unified pane 21 (or 31, 41) which displays both a plurality of pages of a document as thumbnail images 22 (or 32, 42) and a selected page of the document in the main image area 23 (or 33, 43). In the GUI layout of FIG. 2c, the thumbnail images 32 include two groups of thumbnail images having different sizes, where the larger thumbnail images correspond to pages of the document that are closer in to the selected page in the page order of the document, and the smaller thumbnail images correspond to pages of the document that are farther away from the selected page in the page order. In the GUI layout of FIG. 2d, the main image 43 overlaps with some of the thumbnails 42, with the main image displayed either as a transparent image or a solid image in front of the overlapped thumbnail images.

In the GUI examples shown in FIGS. 2a-2d, the user can select a thumbnail image (for example, by double clicking on the thumbnail) and have the corresponding document page displayed in the main image area. The main image area allows the user to edit the selected page or perform other desired functions with respect to the selected page. The user may also navigate to different pages of the document by using a next page and a previous page button, by using arrow keys, by typing in a page number in a page number field, etc. In addition, desired operations may be provided for the thumbnails, preferably whole page operations such as rotation of a page, cut and paste of a page, changing fonts of all the text in a given page, etc.

The window 10/20/30/40 may be provided with various control tools such as a menu bar 14/24/34/44 containing various menu items, a button bar 15/25/35/45 containing various functional buttons, scroll bars including right, bottom, left and top scroll bars 16/26a-d/36a-d/46a-d, etc. These control tools can be used by the user to effectuate various functions of the GUI window. Some of the functions are described in detail in the above-referenced commonly owned U.S. patent applications, including movement of the page content within the main image area, scrolling (moving) of thumbnail images in the pane, i.e., to make the multiple thumbnail images physically move up and down or left and right within the pane 21/31/41 so that thumbnail images previously unseen can now be displayed.

A GUI such as that shown in FIGS. 2a-2d provides the user with the ability to streamline the editing process. By using the thumbnail images as a visual reference, the user can scroll through the thumbnail images of the entire document, locate a specific page among the thumbnails, open it in the main image, and then apply desired editing or other functions to that page.

However, such GUI displays have certain drawbacks when used in a print shop Make Ready program. As described earlier, the Make Ready process can be complex and labor-intensive. The print job can include a very large number of pages, with many steps to be carried out for many pages. Sometimes, a document being manipulated contains a large number of pages but only a relatively small number of pages need to be edited. If all pages are displayed as thumbnail images (to the extent they fit in the window pane, with scrolling abilities), the user needs to scroll through the entire document to locate the small number of pages that require editing. This process is also prong to user mistakes, as the user may miss some pages that require editing. In addition, a print shop sometimes employs multiple operators to perform the Make Ready process of a print job, but conventional Make Ready programs does not provide an easy way to break down the task into smaller tasks for work sharing purposes.

According to embodiments of the present invention, an enhanced Make Ready program has a GUI layout of any one of FIGS. 2a-2d (or any other suitable GUI layout), with a filtering function implemented for the thumbnail display. Any GUI layout may be used to implement the present invention, as long as the layout has an area for displaying a plurality of thumbnail images and an area for displaying the main document image. The enhanced Make Ready program facilitates the handling of the Make Ready process by allowing the operators to selectively view pages of the document as thumbnail images, rather than having all pages displayed as thumbnails in an undiscriminating manner. This allows the operator to select, for example, all pages that require manipulation and display these pages as thumbnails while hiding other pages.

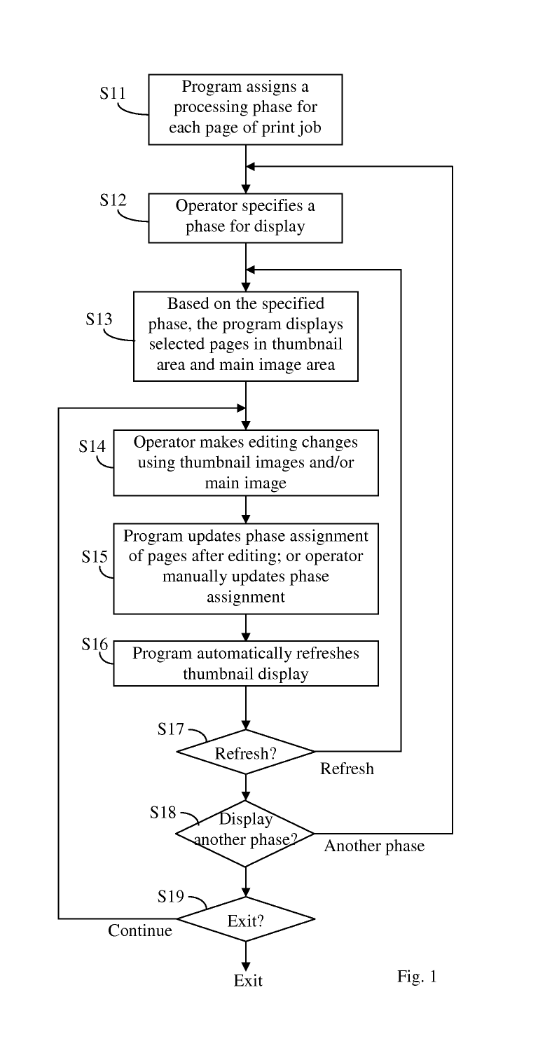

FIG. 1 schematically illustrates a process carried out by the Make Ready program according to an embodiment of the present invention. When the Make Ready program receives a print job for processing, it examines all pages of the document as well as the job ticket (the job ticket of the print job is the collection of parameters defining the printing requirements), and determines a processing phase for each page of the print job (step S11). In a preferred embodiment, each page may have one of four possible processing phases:

Phase A: “Unedited; to be edited”. This phase means that changes are required for this page and no work has begun on these changes.

Phase B: “Edited; requires additional editing”. This phase means that changes were required for this page; some required changes have been made but not all are complete.

Phase C: “Done; not changed”. This phase means that no changes are required for this page.

Phase D: “Done; edited”. This phase means that changes were required for this page, and all required changes have been made and no additional work is required.

In this preferred embodiment, the definitions of the four phases are mutually exclusive. However, mutual exclusivity is not required; in some embodiments, the phases may be defined so that they are not mutually exclusive. For example, in an alternative embodiment, an additional Phase E is defined as “deleted”, which may overlap with the definition of Phase D (to be described in more detail later).

More generally, the processing phase is an attribute of each page that describes a processing status of each page, including whether any editing is required and whether any editing has been done. In the above and following descriptions, the term “phase” or “phase value” is used to refer to this attribute; of course, other descriptive names, such as “processing status value”, may be used to refer to such an attribute.

Initially, when the print job is inputted to the Make Ready program for the first time, each page will be assigned either Phase A (unedited; to be edited) or Phase C (done; not changed) in step S11. The program performs the initial phase assignment based on the contents of the page, the job ticket parameters, and the Make Ready filter settings of the job.

Here, contents of the page refers to the objects on the document page, such as text, image objects, graphics objects, operations of these objects such as rotation, etc. Job ticket parameters refer to printing requirements applicable at printing time, which often affect whole pages or the entire print job, such as paper size, hole punch, staple, etc.

Make Ready filters, in the context of the present invention, are rules that describe what editing are to be performed in the Make Ready stage. Filters will typically refer to contents and/or job ticket parameters relevant to a page. For example, a filter may specify that all pages with hole punch are to be reduced in size and then shifted horizontally by a prescribed amount in order to increase the margin. Another filter may specify that any image larger than a particular size will be size-reduced by a prescribed percentage and have a border added around it. Filters are typically specific to each print job and are inputted to the Make Ready program by the operator, preferably at the time of inputting the print job.

In step S11, the program applies the filters to each page of the print job to determine whether any editing is required for that page. If some editing is required, the page is assigned Phase A. If no editing is required, the page is assigned Phase C.

Once the pages of the print job are assigned the phases, the pages can be selectively displayed to allow viewing and editing. For example, the operator may select phase A to display the pages that require editing and have not been edited. Specifically, the operator will specify a desired phase (step S12); based on the operator's phase selection, the program displays only pages of the specified phase as thumbnails in the pane 11/21/31/41 of the GUI (step S13). If the pane is not sufficient to display all thumbnails for the selected phase, scroll bars will be provided to allow the operator to scroll through the thumbnails. One of the pages will be displayed in the main image area 13/23/33/43.

Thus, the operator is able to view the pages having a particular processing phase alone, without the thumbnail view being cluttered by pages not having the particular processing phase. Once the desired pages are displayed in the thumbnail area, the operator makes editing changes to the displayed pages (step S14). Editing changes may be made to the page being displayed in the main image area, and/or the pages being displayed as thumbnails. The operator may bring any one of the thumbnail pages into the main image area by, for example, double-clicking on the desired thumbnail. Preferably, all editing changes can be made to the main image, while only selected editing changes can be applied to thumbnail images due to their limited display size. Editing change that applicable to thumbnails may include, for example, whole page operations such as rotation of a page, cut and paste of a page, changing fonts of all the text in a given page, etc. The operator may select one or more thumbnail images, e.g., by single-clicking on them, to apply such editing changes to.

After editing has been made to a page, the program automatically updates the phase assignment of the page (step S15). To this end, the program stores information about editing changes that have been made to each page. The phase is changed to either Phase B if some required changes have been made but not all are complete, or Phase D if all required changed have been made and no additional work is required. For example, if the filters indicate that a page requires both shifting and rotation, and only rotation has been done, this information is stored by the program so that the page may be automatically assigned a Phase B (rather than Phase D).

In addition, the operator may manually update the phase assignment of any page (step S15). When doing so, the operator is not constrained by the editing changes that have been made, and can assign a page to any phase he chooses to.

In one embodiment, after any phase re-assignment (either automatic or manual is step S15), the program automatically refreshes the thumbnail display to reflect the new phase assignment (step S16). For example, if initially Phase A pages are displayed as thumbnails, after the operator makes editing changes on one of these pages (step S14), the phase assignment is automatically changed from Phase A to Phase B or Phase D (step S15), and the thumbnail display is automatically refreshed so that this page is no longer displayed as a thumbnail.

To facilitate automatic phase re-assignment and automatic refreshing, a command is provided in the program to allow the operator to indicate to the program that he is, at least for the time being, done with editing of the selected page(s). For convenience, this command may be referred to as the “Update page” command. Upon receiving the “Update page” command, the program performs the automatic phase re-assignment step (S15) for the page and the automatic refresh step (S16). The “Update page” command may be implemented in the GUI by various suitable means, including a menu item in the menu bar, a button in the button bar, a popup menu, key strokes (e.g. control key strokes), etc. Another exemplary implantation of the “Update page” command is to provide an icon within the GUI window, and the operator can “drag and drop” the main image or a thumbnail image into the “Update page” icon, which constitutes the “Update page” command.

In an alternative embodiment, the program does not automatically refresh the thumbnail display (i.e. it does not automatically perform step S16); however, at any point during in the process, the operator may choose to refresh the thumbnail display (step S17). For example, if initially Phase A pages are displayed as thumbnails, and the operator makes editing changes on some of these pages (so that these pages are changed from Phase A to Phase B or Phase D) and then refreshes the thumbnail display, then only the pages that remain in Phase A will be displayed.

The operator may also choose a different phase for display at any point (step S18). In the above example, after making changes to some pages, the operator may choose to display Phase B pages to view all pages that have been edited but still require more editing.

At any point, the operator may save the print job and close it from the Make Ready program, so that the current phases of the pages are saved along with the print job (“Exit” in step S19). Later, the same operator or another operator may open the saved print job in the Make Ready program and continue to work on it.

At the end of the Make Ready process, all pages should be in Phase C or Phase D, i.e., any and all required editing is completed. At this point, the operator can choose to display Phase A or Phase B pages, and no pages will be displayed. This would indicate to the operator that the Make Ready task is complete. On the other hand, if some pages are still displayed in the Phase A or Phase B display, the operator will understand that some work is still required.

Further, if a review is required before the print job is sent to printers for printing, Phase D may be selected to display all pages for which editing is required and has been completed, thereby facilitating the review.

It should be noted that while the flow chart of FIG. 1 presents various steps of the editing process, the actual Make Ready editing process tends to be highly interactive and many steps may be repeated many times in various orders, and some steps shown in FIG. 1 may be omitted. Thus, the flow shown in FIG. 1 should not be viewed as a rigid sequence.

FIG. 2e illustrates another GUI layout according to an embodiment of the present invention. The GUI window 50 has a unified pane 51 which displays both a plurality of pages of a document as thumbnail images 52a, 52b and a selected page of the document in the main image area 53. The thumbnail images 52a, 52b include thumbnail images of different sizes; generally, larger thumbnails correspond to pages of the document that are relatively closer in to the selected page in the page order of the document, and are also physically located closer to the main image area 53. The menu bar 54, button bar 55, and scroll bars 56a-d are similar to the corresponding features in FIGS. 2b-d.

In this GUI, a number of thumbnail images 52a in each of the four phases are displayed, with four labels 58 displayed adjacent to them that indicate the identity of the four phases. The thumbnails belonging to each phase are displayed in an area adjacent to the corresponding label. In FIG. 2e, the phase values A-D are used as the labels, but in actual implementations, more descriptive labels may be preferred. This display allows the operator to see a number of thumbnails for each phase in a glance. In addition, thumbnail images belonging to a selected phase are displayed in another area of the pane, in this example, to the right of the main image 53, as depicted by thumbnails 52b. This allows the operator to see more thumbnails for a particular phase he chooses. Noted that some pages of the document may be displayed both as thumbnail 52a and as thumbnail 52b.

In addition, two icons 57a and 57b are provided to allow the operator to update the phase assignment for a page. The icons 57a and 57b are labeled “Done” (meaning no more editing is requires) and “To Edit” (meaning more editing is still requires), respectively. When the operator wishes to update the phase assignment of a page, for example, after he edits the main image 53, the operator can “drag and drop” the page into the icon 57a or 57b depending on his intention. The program then automatically updates the phase assignment of the page. For example, a page dropped into the “Done” icon 57a will be automatically re-assigned to Phase C (“Done; not changed”) or Phase D (“Done; edited”) Likewise, a page dropped into the “To Edit” icon 57b will be automatically re-assigned to Phase A (“Unedited; to be edited”) or Phase B (“Edited; requires additional editing”). The program can make the re-assignment automatically after the operator drops the page into the icons because the program stores the information regarding whether any changes have been made to the page. The use of the icons 57a and 57b may be considered a hybrid manual and automatic phase re-assignment because it involves both the decision of the operator and the decision of the program. In lieu of the icons 57a and 57b, other means may be used to inform the program of the operator's intent, such as by using menu items, buttons, popup menu, key strokes, etc.

The GUI layout of FIG. 2e is currently preferred (best mode) for implementing a Make Ready program according to embodiments of the present invention. While FIG. 2e depicts a particular spatial arrangement of the various features such as the groups of thumbnail images 52a and 52b, the labels 58 and the icons 57a and 57b, different spatial arrangements may be used.

In another embodiment of the present invention, in addition to Phases A through D described above, a Phase E is defined as “Deleted”. One practical example of Phase E is when the document is a scanned document, where the document may contain blank pages which should be deleted before printing. Thus, the operator performs the editing function to delete these pages. The deleted pages may be assigned Phase E. The operator may choose to display only pages belonging to Phase E, which helps the operator to verify that the deletions are correct. Note that in this embodiment, the definition of Phase E and Phase D overlap with each other. Thus, a page may be assigned two phase values (D and E). Alternatively, the definition of Phase D may be changed to exclude deleted pages so Phase D and Phase E do not overlap.

To summarize, embodiments of the present invention provide a Make Ready program with filtering abilities to isolate pages of a print job based on the editing needed for the pages. The filtering ability is especially helpful in many situations often encountered in the Make Ready stage. For example, when the document contains a large number of pages but only a relatively small number of pages need to be edited, the pages that require editing can be readily identified and displayed to the operator. It also reduced operator mistakes, such as missing one of the small number of pages that require editing. Moreover, by assigning each page one of the four phase values, the Make Ready process can be broken into smaller, more specific sub-tasks, and the operators can move more effectively through the process. In particular, when multiple operators share the Make Ready process of a job, Phase B is useful for managing tasks that are shared between multiple users. The selective display abilities make the entire Make Ready process easier to manage and to complete.

In the above described embodiments, various window control tools such as a menu bar, a button bar, scroll bars, popup menu, etc. are used for controlling various aspects of the thumbnail and main image display of the GUI, as well as to perform editing functions. It should be noted that the control tools useful for implementing the various window functions are not limited to those specifically described in this disclosure. More generally, any suitable window control tools may be used to implement the desired functions.

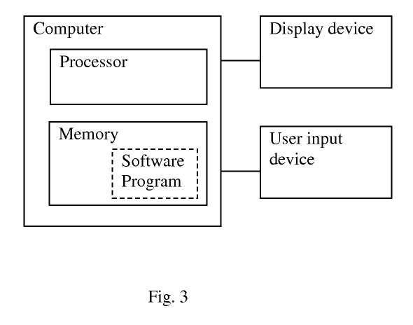

The user interface display methods described above can be implemented in a computer system which includes a processor and a memory storing a software program executed by the processor (see FIG. 3). The computer system also includes a display device for displaying the GUI window, as well as a user input device such as a keyboard and mouse for the user to input commands to the computer system. In one aspect, the invention is a method carried out by a computer system. In another aspect, the invention is computer program product embodied in computer usable non-transitory medium having a computer readable program code embedded therein for controlling a computer system.

It will be apparent to those skilled in the art that various modification and variations can be made in the user interface display and related method of the present invention without departing from the spirit or scope of the invention. Thus, it is intended that the present invention cover modifications and variations that come within the scope of the appended claims and their equivalents.

What is claimed is:

1. A computer-implemented method for processing a document containing multiple pages, the method comprising:
(a) assigning a processing status value to each page of the document, the assigned processing status value being one of a plurality of pre-defined processing status values which correspond to a plurality of processing statuses;
(b) receiving a first input from an operator specifying one of the plurality of pre-defined processing status values;
(c) displaying a plurality of pages of the document having the specified processing status value as thumbnail images in a graphical user interface (GUI) display;
(d) displaying one page of the document as a main image in the GUI display;
(e) carrying out editing changes on one or more of the pages displayed as thumbnail images or the main image; and
(f) updating the processing status value of each page of the document for which editing changes have been carried out, wherein the updating is performed automatically or in response to a second input received from the operator.

2. The method of claim 1, wherein in step (a), the processing status value for each page represents whether any editing is required for the page and whether any editing has been done for the page.

3. The method of claim 1, wherein the plurality of pre-defined processing status values include a first processing status value which indicates that changes are required for the page and no editing has been done on the page.

4. The method of claim 3, wherein the plurality of pre-defined processing status values further include a second processing status value which indicates that changes were required for the page and that some of the required changes have been made but not all are complete, a third processing status value which indicates that no changes are required for the page, and a fourth processing status value which indicates that changes were required for the page and that all required changes have been made and no additional work is required.

5. The method of claim 4, wherein the plurality of pre-defined processing status values further includes a fifth processing status value which indicates that the page is deleted.

6. The method of claim 4, wherein each page of the document is initially assigned either the first processing status value or the third processing status value in step (a).

7. The method of claim 6, wherein the document is a part of a print job, the print job including the document and a job ticket containing one or more job ticket parameters describing printing requirements, wherein the assigning step (a) includes applying one or more filters to each page to determine whether any editing is required for that page, wherein each filter describes one or more editing changes to be made depending on contents of the page and/or the job ticket parameters relevant to the page.

8. The method of claim 6, wherein in step (f) the processing status value of some pages are updated from the first processing status value to the second or fourth processing status value, and the processing status value of some pages are updated from the second processing status value to the fourth processing status value.

9. The method of claim 1, wherein in step (c), the plurality of pages of the document having the specified processing status value are displayed without displaying any pages not having the specified processing status values.

10. The method of claim 1, further comprising, after step (f):
(g) receiving a third input from the operator specifying one of the plurality of pre-defined processing status values; and
(h) re-displaying a plurality of pages of the document having the specified processing status value as thumbnail images in the GUI display.

11. The method of claim 1, wherein in steps (c) and (d), the plurality of thumbnail images and the main image are displayed in a same pane of a window of the GUI, wherein the main image are larger than the thumbnail images, and wherein the thumbnail images and the main image are non-overlapping with each other.

12. The method of claim 11, wherein the thumbnail images include a first group of thumbnail images and a second group of thumbnail images, wherein the thumbnail images in the first group have a different size than the thumbnail images in the second group.

13. The method of claim 1, wherein in steps (c) and (d), the plurality of thumbnail images and the main image are displayed in a same pane of a window of the GUI, wherein the main image are larger than the thumbnail images, wherein the main image overlaps with at least some of the thumbnail images, and wherein the main image is displayed either as a transparent image or as a solid image.

14. A computer program product comprising a computer usable non-transitory medium having a computer readable program code embedded therein for controlling a computer system, the computer readable program code being configured to cause the computer system to execute a process for processing a document containing multiple pages, wherein the process comprises:
(a) assigning a processing status value to each page of the document, the assigned processing status value being one of a plurality of pre-defined processing status values which correspond to a plurality of processing statuses;
(b) receiving a first input from an operator specifying one of the plurality of pre-defined processing status values;
(c) displaying a plurality of pages of the document having the specified processing status value as thumbnail images in a graphical user interface (GUI) display;
(d) displaying one page of the document as a main image in the GUI display;
(e) carrying out editing changes on one or more of the pages displayed as thumbnail images or the main image; and
(f) updating the processing status value of each page of the document for which editing changes have been carried out, wherein the updating is performed automatically or in response to a second input received from the operator.

15. The computer program product of claim 14, wherein in step (a), the processing status value for each page represents whether any editing is required for the page and whether any editing has been done for the page.

16. The computer program product of claim 14, wherein the plurality of pre-defined processing status values include a first processing status value which indicates that changes are required for the page and no editing has been done on the page.

17. The computer program product of claim 16, wherein the plurality of pre-defined processing status values further include a second processing status value which indicates that changes were required for the page and that some of the required changes have been made but not all are complete, a third processing status value which indicates that no changes are required for the page, and a fourth processing status value which indicates that changes were required for the page and that all required changes have been made and no additional work is required.

18. The computer program product of claim 17, wherein the plurality of pre-defined processing status values further includes a fifth processing status value which indicates that the page is deleted.

19. The computer program product of claim 17, wherein each page of the document is initially assigned either the first processing status value or the third processing status value in step (a).

20. The computer program product of claim 19, wherein the document is a part of a print job, the print job including the document and a job ticket containing one or more job ticket parameters describing printing requirements, wherein the assigning step (a) includes applying one or more filters to each page to determine whether any editing is required for that page, wherein each filter describes one or more editing changes to be made depending on contents of the page and/or the job ticket parameters relevant to the page.

21. The computer program product of claim 19, wherein in step (f) the processing status value of some pages are updated from the first processing status value to the second or fourth processing status value, and the processing status value of some pages are updated from the second processing status value to the fourth processing status value.

22. The computer program product of claim 14, wherein in step (c), the plurality of pages of the document having the specified processing status value are displayed without displaying any pages not having the specified processing status values.

23. The computer program product of claim 14, wherein the process further comprises, after step (f):
(g) receiving a third input from the operator specifying one of the plurality of pre-defined processing status values; and
(h) re-displaying a plurality of pages of the document having the specified processing status value as thumbnail images in the GUI display.

24. The computer program product of claim 14, wherein in steps (c) and (d), the plurality of thumbnail images and the main image are displayed in a same pane of a window of the GUI, wherein the main image are larger than the thumbnail images, and wherein the thumbnail images and the main image are non-overlapping with each other.

25. The computer program product of claim 24, wherein the thumbnail images include a first group of thumbnail images and a second group of thumbnail images, wherein the thumbnail images in the first group have a different size than the thumbnail images in the second group.

26. The computer program product of claim 14, wherein in steps (c) and (d), the plurality of thumbnail images and the main image are displayed in a same pane of a window of the GUI, wherein the main image are larger than the thumbnail images, wherein the main image overlaps with at least some of the thumbnail images, and wherein the main image is displayed either as a transparent image or as a solid image.
